(19) United States
(12) Patent Application Publication
(10) Pub. No.: US 2026/0285206 A1
(43) Pub. Date: Sep. 24, 2026

(54) Child safety latch system for vehicle seats and method of use

(71) Applicant: Premier Products, Inc., Marlton, NJ (US)

(72) Inventor: David Slater, Elkhart, IN (US)

(21) Appl. No.: 17/988,201

(22) Filed: Nov. 16, 2022

(51) Int. Cl. B60N 2/28; B60N 2/34

(52) U.S. Cl. CPC B60N 2/2806; B60N 2/34

(57) ABSTRACT

A sofa assembly, comprising a sofa back and a sofa seat which can transform from an upright, seat orientation into a lay-flat, bed orientation. Cavities within the seat cushion allow access to seat belt buckles, which are rigidly or semi-rigidly attached to the sofa support structure, which is well known to someone skilled in the arts. Adapter clips can be inserted into the seat belt buckles to function as child safety seat retention clips. Other adapter clips can be inserted into the seat belt buckles to provide support to a filler block when the sofa assembly is in the lay-flat, bed orientation.

### BACKGROUND OF THE INVENTION

### 1. Field of the Invention

The present invention relates generally to child safety latches and method for use thereof, and more specifically to child safety latches for vehicle seats which can be removed and filled in with filler blocks.

### 2. Description of the Related Art

Luxury vans and recreational vehicles are often outfitted with sofas which can be transferred into beds for sleeping while traveling. Unfortunately, these sofas are rarely the most comfortable place to sleep in when converted into the bed. The seat belt clips for these sofas also tend to protrude into the sleeping space between the cushions, causing additional discomfort. Furthermore, existing sleeping sofas for vehicles lack child safety restraint hooks for securing car seats or other child support and restraint devices to the seat.

Heretofore there has not been available a system or method for child safety latches for vehicle seats with the advantages and features of the present invention.

### BRIEF SUMMARY OF THE INVENTION

The present invention generally provides a sofa assembly for a vehicle. The sofa assembly is transformable from a sofa configuration with a seat cushion and a rear cushion forming an angle, to a bed configuration where the seat cushion and rear cushion are laid flat. A safety latch system includes a safety latch receiver which can receive a safety latch insert. In a preferred embodiment, the safety latch receiver and safety latch insert resemble the insert and receiver used for seatbelts. The safety latch insert can be clicked into the safety latch receiver until the user decides to release it via a release button on the safety latch receiver.

When the safety latch system is not in use, the safety latch insert can be removed, the safety latch receiver can be tucked into a cavity within the seat cushion, and a filler insert can be clipped into the safety latch receiver instead. A filler block fills the cavity, providing a more comfortable lay-flat bed orientation.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a prior art vehicle sofa seat shown in an upright, sofa orientation.

FIG. 2 is a three-dimensional isometric view thereof shown in an lay-flat, bed orientation.

FIG. 3 is a three-dimensional isometric view of a preferred embodiment vehicle sofa seat shown in an upright, sofa orientation.

FIG. 3A is a detailed view taken about the circle of FIG. 3.

FIG. 4 is a three-dimensional isometric view thereof, showing safety latch receivers being tucked within a cavity element of the seat cushion element thereof.

FIG. 4A is a detailed view taken about the circle of FIG. 4.

FIG. 5 is a three-dimensional isometric view of a safety latch insert element thereof.

FIG. 6 is a three-dimensional isometric view of a frame element thereof.

FIG. 7 is a three-dimensional isometric view of the preferred embodiment vehicle sofa seat wherein the safety latch insert elements are received within the safety latch receiver elements.

FIG. 7A is a detailed view taken about the circle of FIG. 7.

FIG. 8 is a three-dimensional isometric view thereof shown in a lay-flat, bed orientation.

FIG. 9 is a three-dimensional isometric view of a filler insert clip element thereof.

FIG. 10 is a three-dimensional isometric view thereof including a filler block element.

FIG. 11 is a three-dimensional isometric view of the vehicle sofa seat shown in a lay-flat, bed orientation receiving the filler insert clips and filler blocks thereof.

FIG. 11A is a detailed view taken about the circle of FIG. 11.

FIG. 12 is a three-dimensional isometric view thereof shown with the filler blocks fully filling the cavities thereof.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Prior Embodiment Vehicle Sofa Seat System 2 Child Restraints 10

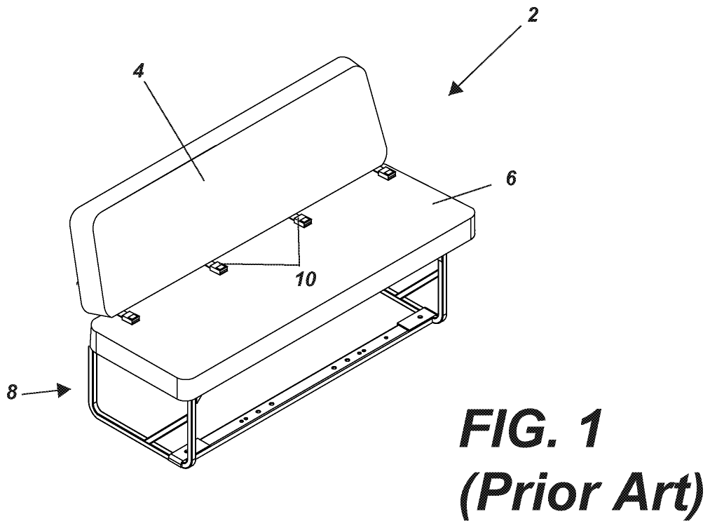

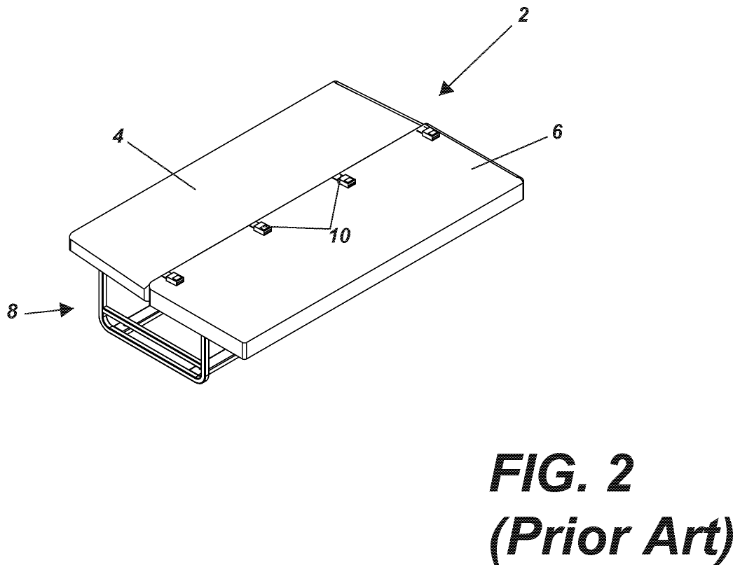

FIGS. 1 and 2 show a prior art vehicle sofa seat system 2 in an upright, sofa orientation with a seat cushion 6 and rear cushion 4 forming an angle for sitting. The cushions 4, 6 are affixed to a frame 8. Several safety restraint clips 10 are shown sticking out between the rear 4 and seat 6 cushions. These are standard clips which are designed to connect with seat belts, and are connected to the frame 8. FIG. 2 shows how when in the lay-flat bed orientation, these clips remain exposed and produce an uncomfortable obstruction for anyone lying on the bed.

### III. Preferred Embodiment Vehicle Sofa Seat System 102 With Child Restraint System 110

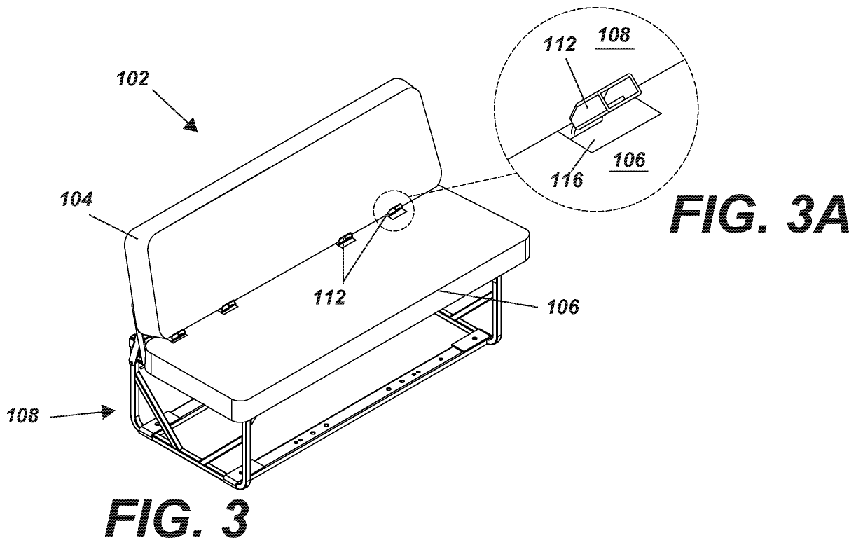

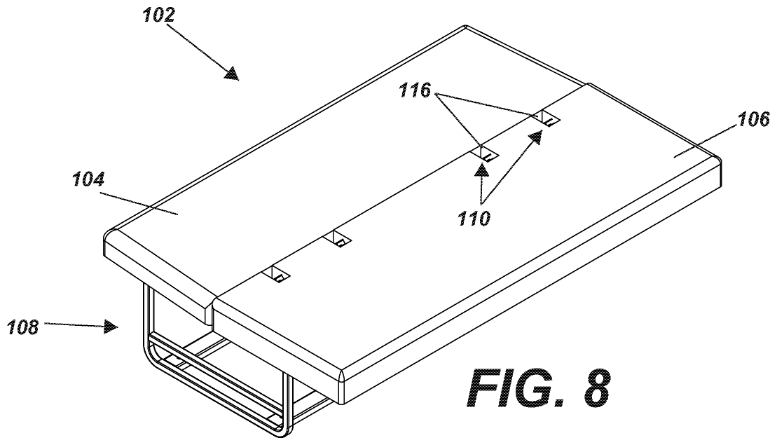

As shown in FIGS. 3-12, the present invention is a vehicle sofa seat system 102 which can transform from an upright, sofa orientation as shown in FIGS. 3, 4, and 7, into a lay-flat, bed orientation as shown in FIGS. 8, 11, and 12. The sofa seat system 102 could be a lay-flat sofa seat as taught by U.S. patent application Ser. No. 17/951,492 and U.S. Pat. Nos. 10,556,524, 10,300,815, and 11,453,318, all of which have a common inventor with the present Application and which have been assigned to a common assignee, all of which are incorporated herein by reference.

FIGS. 3 and 3A show how child safety latch receivers 112 are accessible via cavities 116 within the seat cushion 106. These are shown slightly sticking out from beneath the rear cushion 104. The cushions 104, 106 are affixed to a frame 108. These can be clipped into with standard child safety seats using a standard buckle tang within vehicles if desired. The safety latch receivers 112 can also be used as seat belt clips, but can be modified as described below to function as child safety latch for child safety seats.

The safety latch receivers 112 may be standard seat belt buckles.

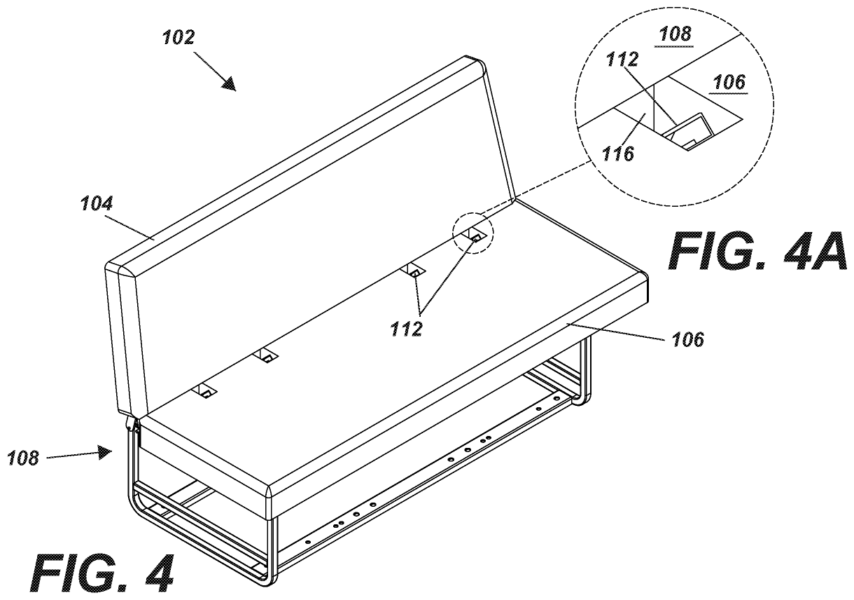

FIGS. 4 and 4A show how the child safety latch receivers 112 of the safety latch system 110 can be tucked down into the cavities 116.

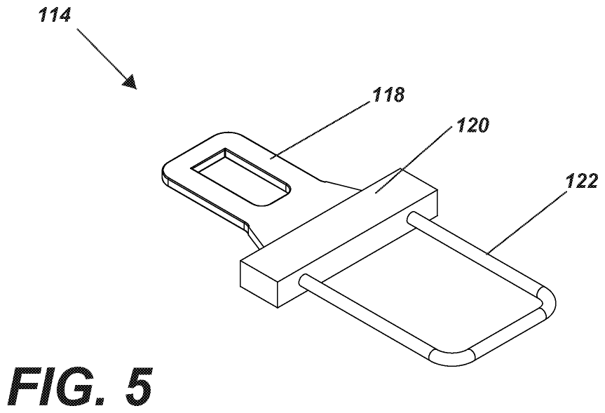

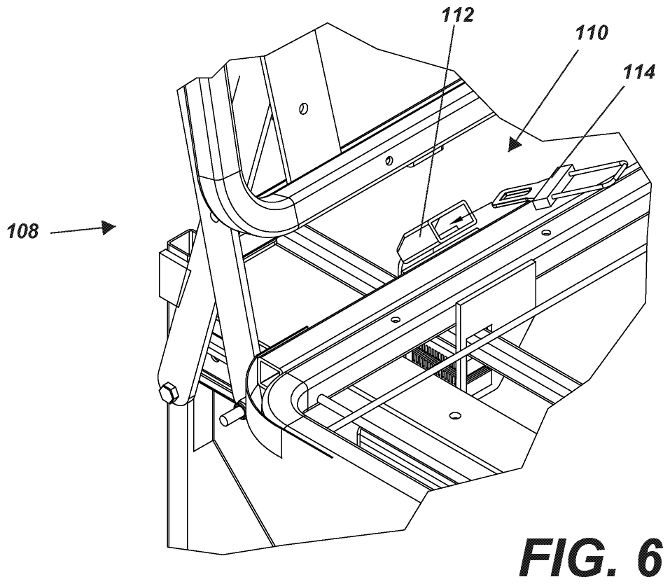

FIG. 5 shows the child safety latch adapter 114 which can be received within the safety latch receivers 112 via the clip end 118 which is a standard buckle tang. A body 120 joins the clip end 118 with a hook end 122 which modifies the safety latch system 110 such that a child tether can be connected to comply with federal law. FIG. 6 shows the frame 108 connected to the safety latch receivers 112 of the safety latch system 110, and it also shows the safety latch adapter 114 being inserted therein.

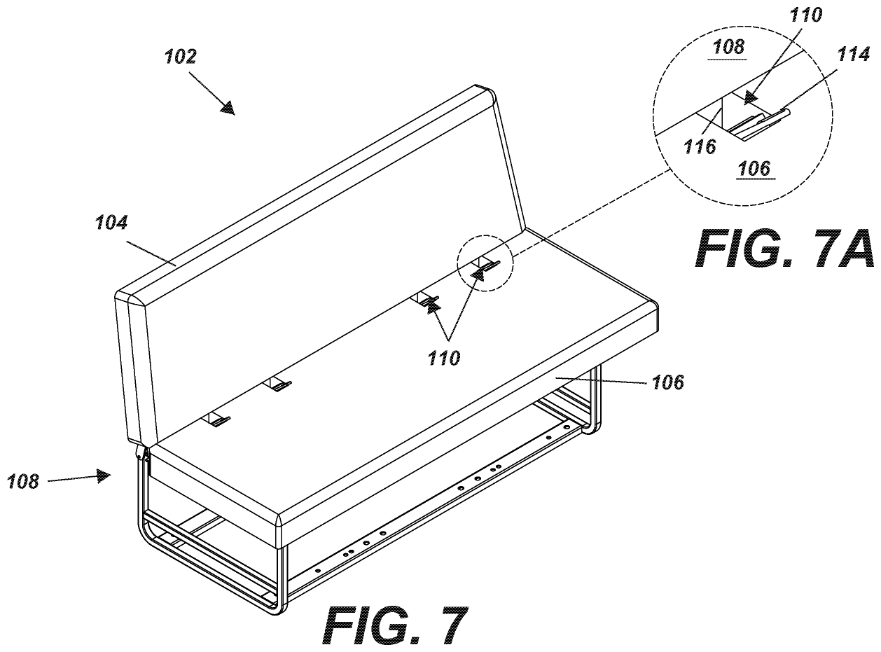

FIGS. 7 and 7A show the vehicle sofa system 102 in the upright, sofa orientation, with the safety latch adapter 114 in place within the receiver 112 of the safety latch system 110, ready to accept a child seat or booster.

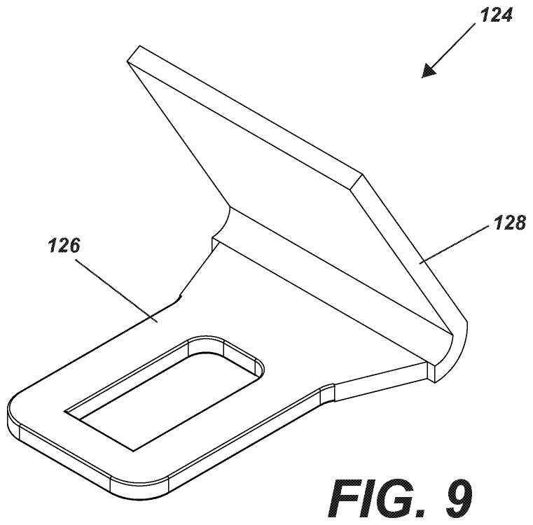

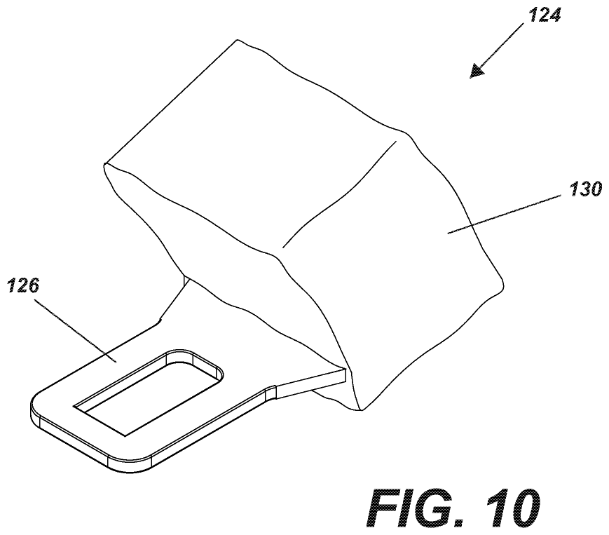

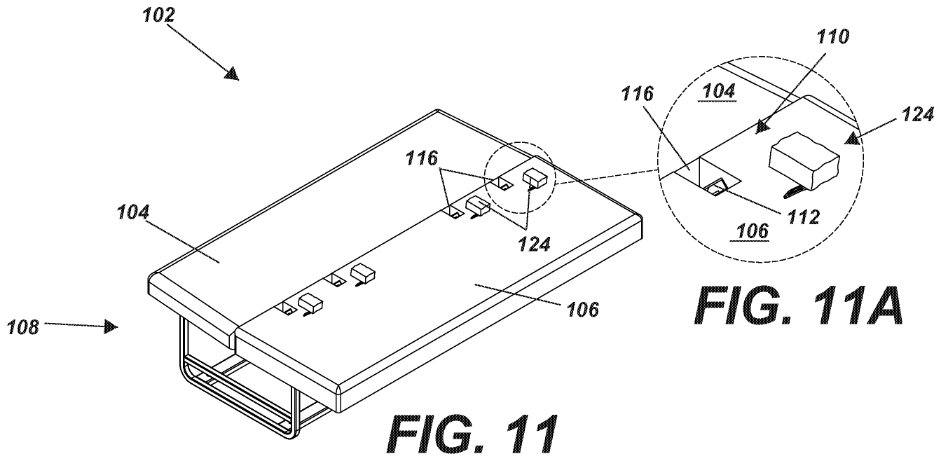

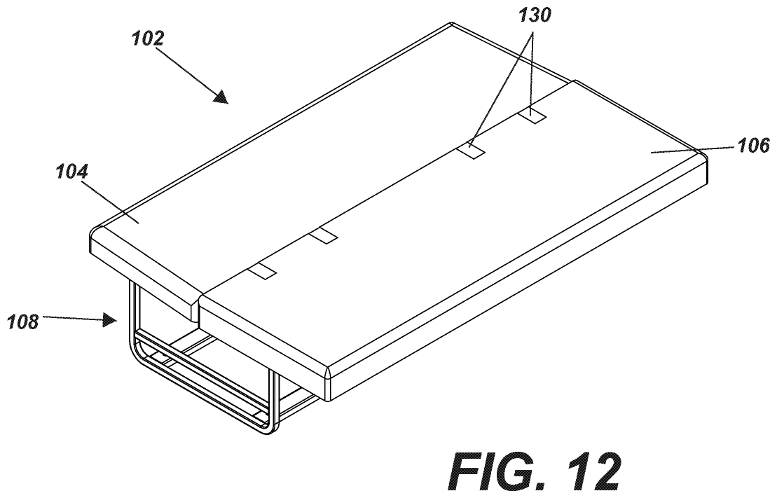

FIG. 8 shows the vehicle sofa system 102 in a lay-flat, bed orientation wherein the safety latch system 110 remains exposed within the cavities 116. FIG. 9 shows a filler insert 124 having a filler insert clip 126 and a base stand 128. FIG. 10 shows a filler block 130 about the base stand 128. The filler insert clip 126 is received by the safety latch receiver 112 of the safety latch system 110, and the filler block 130 fills the cavities 116 as shown in FIGS. 11, 11A, and 12. This provides a smooth sleeping surface for the bed orientation of the sofa system 102 with no holes or uncomfortable safety restraint elements exposed.

It is to be understood that while certain embodiments and/or aspects of the invention have been shown and described, the invention is not limited thereto and encompasses various other embodiments and aspects.

1. A child safety latch system for a vehicle sofa assembly, the system comprising:
a vehicle sofa assembly having a seat cushion and a rear cushion affixed to a frame, said vehicle sofa assembly configured to be transformed from an upright, sofa orientation to a lay-flat, bed orientation;
said seat cushion comprising a cavity housing a safety latch receiver, wherein said safety latch receiver can be selectively tucked within said cavity;
an adapter assembly comprising a clip configured to be received by said safety latch receiver, said adapter assembly further comprising a tether hook configured for interfacing with a child safety seat; and
said adapter assembly configured to be selectively removable from said safety latch receiver.

2. The system of claim 1, further comprising:
a filler adapter comprising a filler clip configured to be received by said safety latch receiver, said filler adapter further comprising a filler base; and
a filler block configured to engage with said filler base, said filler block configured to fill said cavity thereby creating a smooth surface when said vehicle sofa assembly is in said lay-flat, bed orientation.

3. The system of claim 2, wherein said filler block is made of the same material as said seat cushion.

4. The system of claim 1, wherein said safety latch receiver comprises a standard seat belt buckle.

5. A child safety latch system comprising:
a safety latch receiver comprising a release switch;
an adapter assembly having a first end comprising a clip and a second end comprising a loop;
said clip configured to be releasably received within said safety latch receiver;
said hook configured to receive a safety tether for securing a child seat; and
wherein said release switch is configured to release said clip from said safety latch receiver.

6. The system of claim 5, wherein said safety latch receiver is contained within a cavity within a seat cushion of a vehicle seat.

7. The system of claim 6, further comprising:
a filler adapter comprising a filler clip configured to be received by said safety latch receiver, said filler adapter further comprising a filler base; and
a filler block configured to engage with said filler base, said filler block configured to fill said cavity thereby creating a smooth surface within said seat cushion.

8. The system of claim 5, further comprising:
said safety latch receiver comprises a standard seat belt buckle; and
said clip comprising a standard seat belt buckle tang.

9. A child safety latch system comprising:
a safety latch receiver including a release button;
an adapter assembly comprising a clip configured to be received by said safety latch receiver, said adapter assembly further comprising a tether hook configured for interfacing with a child safety seat; and
said adapter assembly configured to be selectively removable from said safety latch receiver by activating said release button.

10. The system of claim 9, further comprising:
said safety latch receiver comprising a vehicle seat belt buckle; and
said clip comprising a standard seat belt buckle tang.

11. The system of claim 9, further comprising:
said safety latch receiver affixed to a vehicle seat frame; and
a seat cushion comprising a cavity configured to house said safety latch receiver.

12. The system of claim 11, further comprising:
a filler adapter comprising a filler clip configured to be received by said safety latch receiver, said filler adapter further comprising a filler base; and
a filler block configured to engage with said filler base, said filler block configured to fill said cavity thereby creating a smooth surface within said seat cushion
